(19) United States
(12) Patent Application Publication
(10) Pub. No.: US 2011/0131851 A1
(43) Pub. Date: Jun. 9, 2011

(54) Personal Marquee: a media packaging display apparatus

(76) Inventors: Stephen L. Hite, Redwood City, CA (US); Michael P. Hite, Hayward, CA (US); Ross Thomas Hite, Burlingame, CA (US)

(21) Appl. No.: 12/927,874

(22) Filed: Nov. 29, 2010

Related U.S. Application Data
(60) Provisional application No. 61/283,496, filed on Dec. 5, 2009.

(51) Int. Cl. G09F 15/00; A47G 1/08; H04N 5/64

(52) U.S. Cl. 40/606.13; 348/836; 40/700; 348/E05.128

(57) ABSTRACT

An apparatus with display and base for media cases and/or packaging is provided. This includes, but is not limited to, the cases or packaging for DVDs, Blu-ray Discs, CDs, video or computer games, and VCR tapes. The apparatus, called a “Personal Marquee,” is capable of holding an individual case standing upright such that a substantial portion of the cover of the case is visible to the user. The artwork on the apparatus is designed to evoke the sense of the facade of a classical movie theater with its “Now Showing” marquee. The media display includes a base for support, an upright section for holding the media case, and a riser if necessary to accommodate cases of different sizes. The upright is attached to the base or is integral with the base and has an opening in front through which the media case is visible.

### CROSS-REFERENCE TO RELATED APPLICATIONS

This application claims benefit of the previously filed provisional patent application No. 61/283,496, filed on Jan. 5, 2009.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present disclosure relates to a display apparatus for media packaging and cases associated with consumer playback content, for example, the packaging and case for a DVD, Blu-ray Disc, CD, video game, or VCR tape. The apparatus itself contains artwork designed to evoke the sense of the facade of a classical movie theater with its “Now Showing” marquee.

Movie theaters traditionally have a marquee over the front entrance. This is a distinctive architectural feature usually in the form of a canopy projecting over the main entrance of the theater which states the current movies being shown. Posters for the current movies and coming attractions are also displayed in the front of the theater or entryway. Music venues also have similar marquees and displays. The nostalgia associated with the traditional marquee and these types of displays have aesthetic value to consumers.

More and more media consumption takes place using digital media at home. People also like displaying movie posters and the like around the home or in commercial establishments to conjure up the feeling of going to the movies at a public theater or the feeling of experiencing the displayed media. Picture frames, book stands, holders for collector plates, and collectible display cases are all ways that we display items of value, artistic merit, and personal meaning. When people watch a movie, listen to a CD, or play a computer game at home or elsewhere, the media (such as a DVD disc) is taken from its case and put in the appropriate console or player, and the media packaging is put aside, to be found later when it is time to put the media away. Often, and as media is getting smaller and smaller, packaging can more easily be misplaced. The case itself and its associated artwork are almost always an afterthought after the initial purchase.

Watching movies, listening to music CDs, and playing video and computer games are experiences of relatively short duration—a few hours or so. When people choose to watch a movie using analog or digital media at home or in some other noncommercial setting, they lose out on the atmosphere and anticipation of seeing the movie posters and concert promotions often observed before attendance at a movie theater or music concert. Properly displayed, the media case itself, with its artwork and movie poster look and feel, can become part of the experience, enhance the experience, and help evoke the feeling of being “at the movies” while in an alternate setting. A display case to accomplish these goals and minimize the loss of media packaging is disclosed.

An additional advantage to this device is peripheral advertising and marketing that can be included surrounding the media packaging display window. The area of the apparatus used to display the artwork can also include advertising or company logos or trademarks. This utility would be realized by companies or other commercial or non-profit entities which wanted to personalize the apparatus as part of their marketing materials.

### BRIEF SUMMARY OF THE INVENTION

An apparatus with display and base for media cases and/or packaging is provided. The “Personal Marquee: A Media Packaging Display Apparatus” (or “Personal Marquee” for short) is capable of holding an individual case standing upright such that the cover of the case is visible to the user. The artwork on the apparatus is designed to evoke the sense of the facade of a classical movie theater with its “Now Showing” marquee. The media display includes a base for support and an upright section for holding the media case. The upright is attached to the base or is integral with the base and has an opening in front through which the media case is visible.

The present invention relates generally to items for displaying objects of interest such as picture frames and plate holders. However, the invention is meant to hold the media packaging or case and its associated artwork while the media itself is in use. Specifically, it is meant to hold the case or related artwork for such items, including, but not limited to: DVD, Blu-ray Disc, video or computer game, music CD, and VCR tape, while the item is in use. The media packaging is held in a standing, or upright, position that allows for display of the media packaging in close proximity to the media playback device wherein the user of the media can visually access the packaging materials in the “now showing” display.

The disclosed invention is an item designed to hold multiple types of media packaging and its associated artwork, including, but not limited to, movie DVDs or Blu-ray Discs, software DVDs, VCR tapes, video games in digital form, and music CD discs such that the cover of the case or its artwork is displayed. The media packaging typically would slide into an opening located on the top of the display section and may be adjustable to center the artwork or associated media packaging in vertical and horizontal positions. The unit is supported by the base of the apparatus such that the display is standing vertically so the user can view the media artwork or associated media packaging. The apparatus is designed to evoke the sense of a social event, such as found in attending a movie theater or music concert. It is intended to be used to hold and display the media packaging. Potential placement is subject to the user's preference, including, but not limited to, the top of a television or monitor, on a coffee table or shelf, or any other place that is convenient and allows the view of the media packaging or for easy retrieval for storage.

The invention is comprised of a base section and a standing display section, either as two pieces or as a single piece which may perform the two necessary functions. The first function is to provide adequate stability for the entire display case. The second function is to provide a method to hold the media case in a vertical position for display. The entire display is decorated with images and colors to give it an appearance similar to the front a traditional movie theater. Words such as “Now Showing” or “Now Playing” are prominent in the upright portion.

The invention is made of sturdy material that allows it to stand upright. In one embodiment, it is paperboard with folds, creases, inserts, and tabs so that it can be assembled quickly by the user. In this form, it is provided to the user in a flat format with step-by-step instructions covering how to reconfigure it into its usable form. The paperboard is preprinted with the marquee artwork. This and alternate embodiments are described herein.

### BRIEF DESCRIPTION OF THE SEVERAL VIEWS OF THE DRAWINGS

FIG. 1, the preferred embodiment, is a perspective view of a display for an individual case that digital media comes in when it is purchased. This perspective view is in accordance with the present invention, illustrating the manner in which the base and upright section are related. This figure does not include the artwork on the display.

FIG. 2 is the same perspective view of the display as in FIG. 1, but with a representative, stylized sample of artwork on the display demonstrating the manner in which the display evokes the look and feel of a traditional movie theater.

FIG. 3 is a perspective view similar to FIG. 1, illustrating the display from the rear.

FIG. 4 is a plan view of the invention.

FIG. 5 is the same perspective view shown in FIG.1, but also illustrating how a media case slides into the top of this embodiment of the invention.

FIG. 6 demonstrates how the invention can be used to display various types of cases, for example, a DVD case, a CD case, and a VHS case.

FIG. 7 is an exploded perspective view illustrating the manner in which the two main components of the display are related. It includes the third component which is a riser used to accommodate a shorter media case as is common with Blu-ray and computer game packaging.

FIG. 8 illustrates an alternate embodiment of the invention wherein the upright section is eliminated and the media case is held directly within the base. A flexible foam or other similar material is used to hold the case upright.

FIG. 9 illustrates an alternate embodiment where in the media case is held on top of the base by means of vertical plates that can be adjusted to various widths to accommodate different-sized media cases.

FIG. 10 illustrates an alternate embodiment in which the separate base is eliminated and the upright is shaped to provide the stability to hold the invention upright; in this case a triangular body extending beyond the horizontal limits of the display section to allow more surface area for the marquee artwork.

FIG. 11A is a front view and 11B a perspective view of an alternate embodiment in which the vertical stability is provided by triangular vanes incorporated into the body of the upright section.

FIG. 12 a perspective view of a single body construction similar to FIG. 10 but without the additional width.

FIG. 13 is a perspective view of an alternate embodiment in which the invention is designed to hang on the wall.

FIG. 14 is a perspective view of an alternate embodiment in which an electronic digital display unit is located at some distance behind the opening in the front of the display section and is adapted to be visible when no media packaging is inserted. This can be used to display digital media information related to the media being used or other information that is transmitted through digital means.

FIG. 15 is a perspective view of an alternate embodiment wherein a barcode reader or similar device is incorporated into the top of the upright section which scans for data to be shown in the digital display screen incorporated into the base.

### DETAILED DESCRIPTION OF THE INVENTION

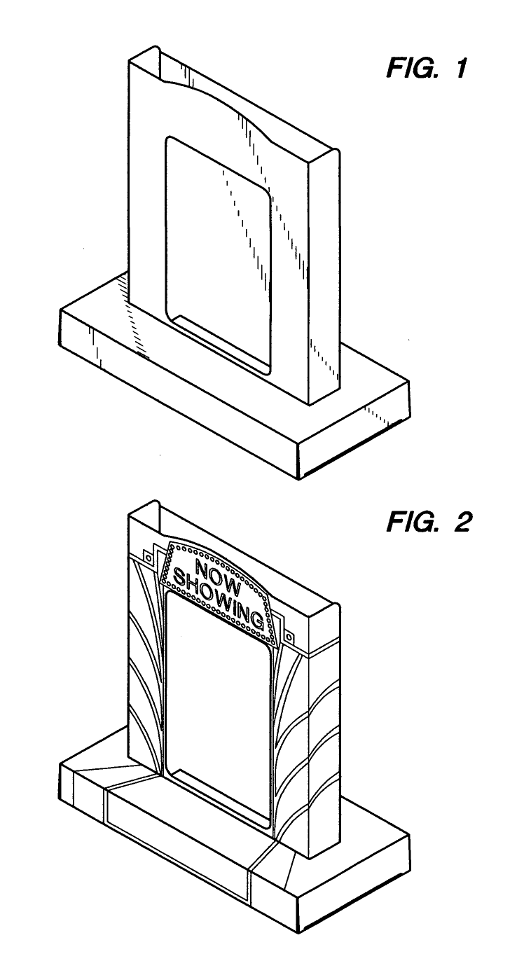

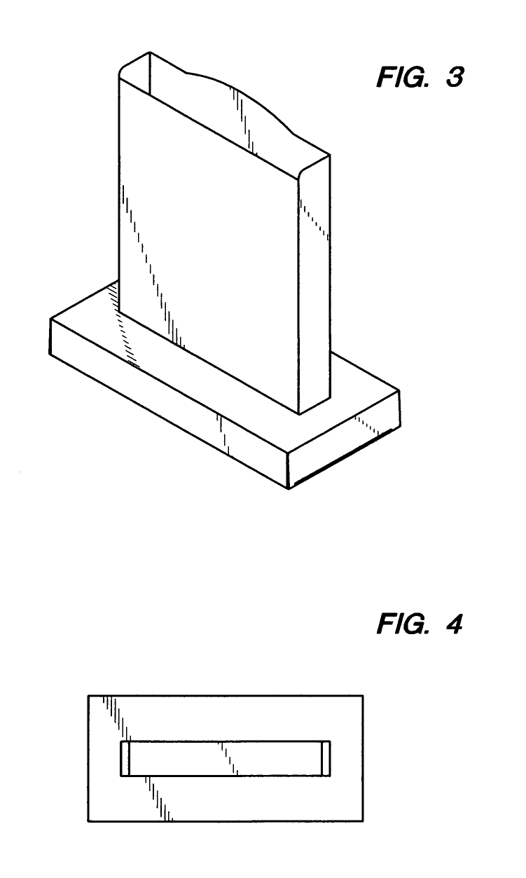

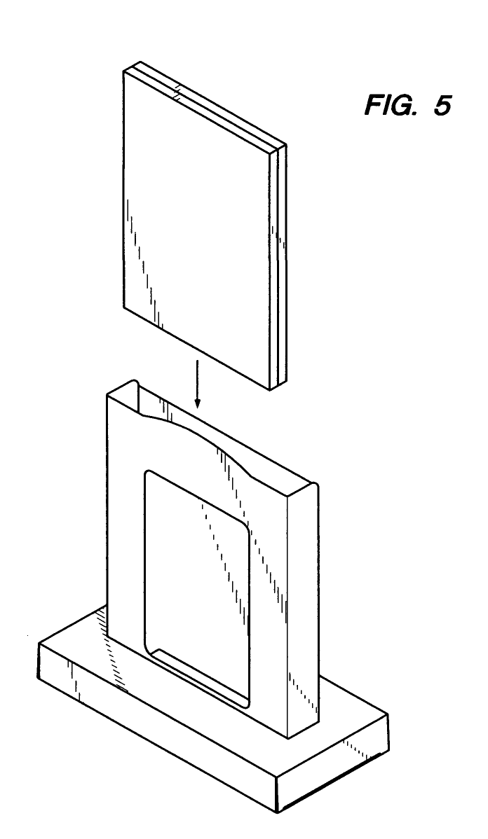

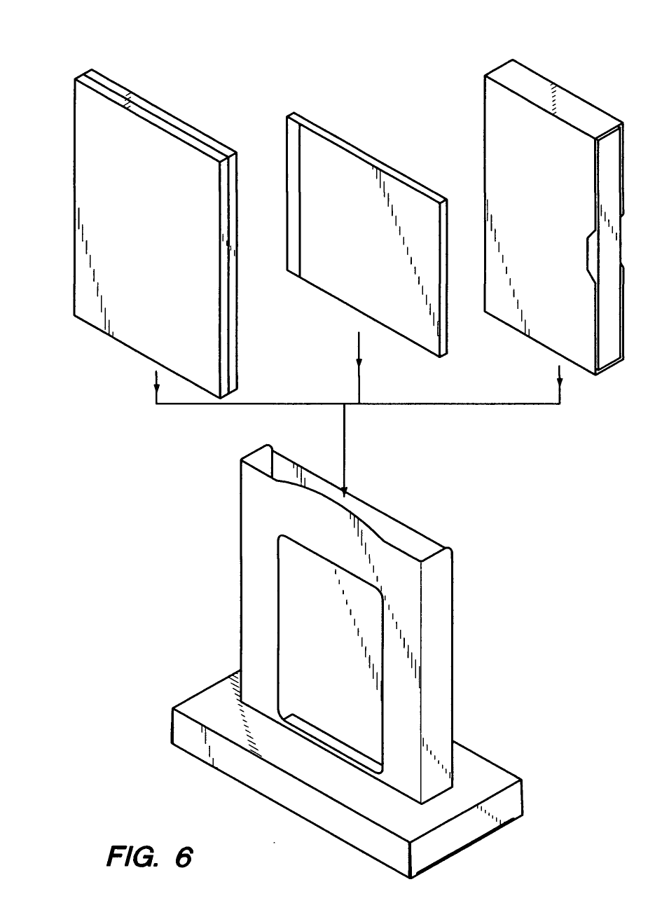

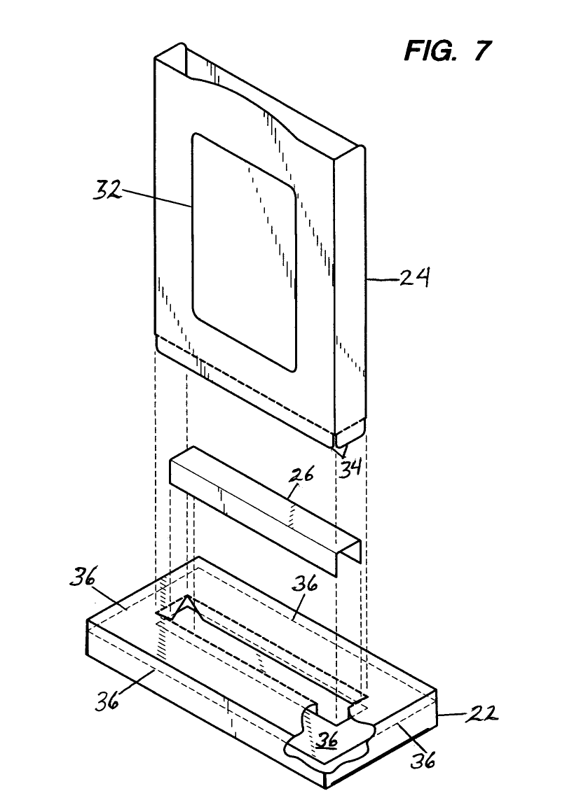

As shown in the drawings for purposes of illustration, the present invention is concerned with displaying a single digital media display case while the media itself is in use. The preferred embodiment of the display is shown in FIG. 1 through FIG. 7 of the accompanying drawings. Its function is to hold a digital media case in an upright position on a stable base. Referring to FIG. 7, the invention comprises a base 22 which has a rectangular shape and is positioned on a flat surface and an upright piece 24 which also has a rectangular shape and slides into the base 22. A third piece 26 is an orientation mechanism (a riser in this embodiment) which is inserted into the base when the display is holding a smaller media case. This acts to hold the case higher in the display to take full advantage of the opening. The two main pieces (the base 22 and the upright 24) are designed to interlock when put together by the user so that the display holds together if the user tips it upside down to remove a media case.

The three pieces are packaged together in the flattened state. The user assembles the pieces per instructions included with the display. The paperboard includes scored lines to facilitate the folding of the various flaps and tabs.

The base 22 starts in a flattened state. When it is pushed into its three-dimensional form, it has traditional box top flaps at each end to maintain the vertical integrity when the flaps are folded into place. These flaps are comprised of three parts—one main flap and two side flaps. The side flaps are folded inwards along scored lines. The main flap is comprised of two sections. The end section is folded along a scored line. Then the main flap is folded inward and the end section is tucked into the opening at each end of the base to close the box. This applies to both ends of the base 22.

The upright piece 24 also starts in a flattened state. It has an opening 32 in the front portion. The purpose of the opening is to allow the user to see the major portion of the front of any digital media case when it is inserted into the display unit. When the upright 24 is pushed into its three-dimensional form, it has four flaps 34 at the base of the upright—one along each side of the rectangular opening. These four flaps are folded outwards and upwards along the scored lines. The purpose of the flaps is to hold the upright in place once it has been inserted into the base 22.

The orientation mechanism (riser) 26 has two scored lines. It is folded along these lines so that it can be placed as a stand in the bottom of the opening of the base 22 to provide additional height to a shorter media case.

The base 22 is designed with a horizontal centerpiece 36 that bisects the interior of the base throughout its entire length (represented by the dashed line around the base 22 midway in its height). The centerpiece 36 has an opening in it that matches the opening in the top of the base. The purpose of the centerpiece 36 is to provide vertical stability to the upright piece 24 when it is inserted in the base.

When the upright 24 with the flaps 34 folded outwards is inserted into the top of the base 22 and through the centerpiece 36, it rests on the interior bottom piece. Upon completion of the insertion, the flaps 34 act in a fashion similar to a barb on a hook and prevent the upright from falling out of the base if the display unit is inverted.

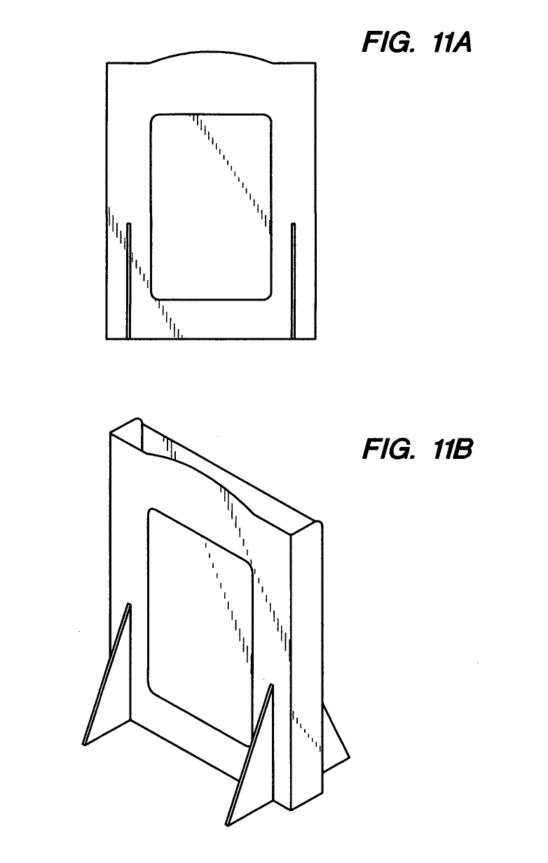

FIGS. 11A and 11B show an alternate embodiment wherein the vertical stability is provided with vanes replacing the need for a full base.

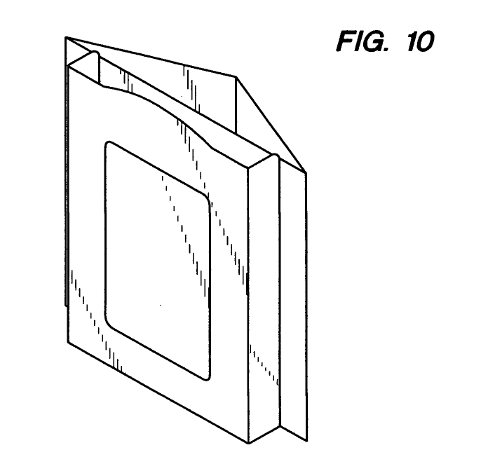

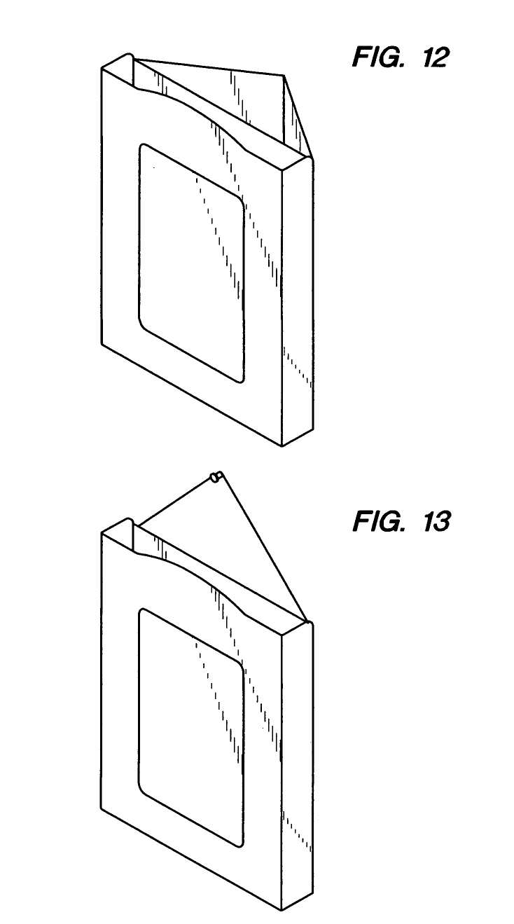

In an alternate embodiment, the invention combines the functions of the base and the upright into a single body, with the riser still as a separate piece. The shape and size of the unit are designed to provide stability as well as the space for displaying the media case. If made from the same paperboard as described above, it would use a similar design of folds and tabs to assemble from a flat state to its three dimensional functional state. FIGS. 10 and 12 shows a perspective view on alternate styles of this embodiment.

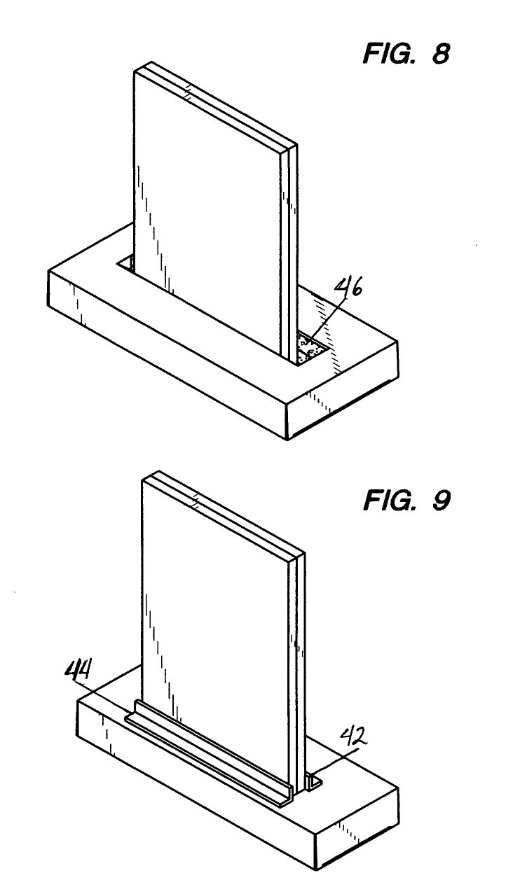

In another alternate embodiment, the base would incorporate the display function and the media case would stand up above it. The base could be taller than the previous embodiments in order to provide the space for the marquee effect. The media case in FIG. 9 would be held rigidly vertical by an adjustable back plate 42 that would pinch the case against a similarly sized front plate 44. Whereas the other embodiments described above can be made from paperboard as well as many other materials (see claims section), this embodiment requires construction from denser materials that allows for the attachment of the vertical plates and the adjustment mechanism to pinch the media case in place. The media case in FIG. 8 would be held rigidly vertical by an insert of flexible foam 46.

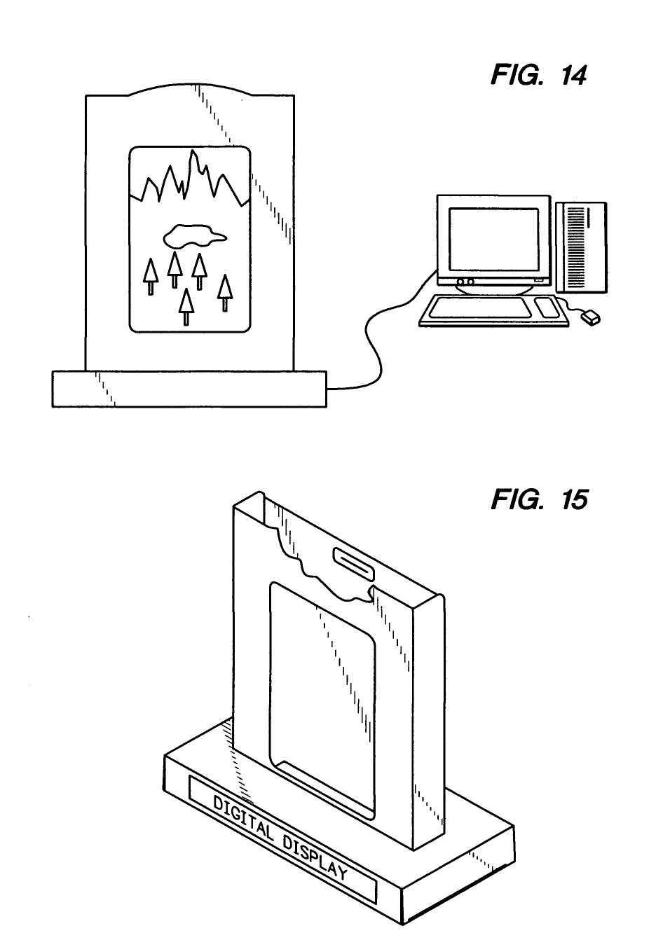

Other embodiments include an upright display section which hold only the artwork associated with the media in non-rigid poster or print-out form. Alternatively, it can be electronically displayed on a screen which is or is part of the display section as in FIG. 14. Or it can be hung on the wall as in FIG. 13. Or the base can serve as an electronic display of information based on digital information coded in the media case as in FIG. 15.

Although particular embodiments of the invention have been described in detail for purposes of illustration, various modifications may be made without departing from the spirit and scope of the invention. These include, but are not limited to, the construction material and the type of artwork and the wording used on the invention. Alternative materials include, but are not limited to: paperboard, cardboard, terracotta, clay, metal, carbon fiber, stone, glass, crystal, plastic, wood, and ceramic; and combinations thereof. Such constructions would be multiple pieces or single-piece units which require no assembly by the user. Accordingly, these modifications are within the scope of the invention as defined in the following claims.

What is claimed is:

1. A digital media case display unit, comprising:
a base section to support a media display case and housing held in a vertical, or near vertical, position of sufficient height, weight, and design;
a display section comprising a housing for media packaging wherein the media packaging is visible to the user or users during access to the media content and is contained within or attached to the housing structure of the display section to allow the packaging or related or associated artwork to be seen; and
an orientation mechanism that allows for adjustment of various sizes of media packaging to be properly centered and visible while housed in or on the display section.

2. The display of claim 1, wherein each of the said sections are made individually of paperboard and designed to be assembled into a complete unit by the user. Its characteristics are as follows:
said base has an opening in the top to accommodate the said vertical display section, and the said vertical display section which is hollow in order to hold a digital media packaging case within this vertical display section and resting within the base;
said hollow upright display section is of sufficient height to hold within it a digital media case, and the said upright display section has an opening in the front to allow the front of the digital media case to be seen by the user or users; and
said orientation mechanism in the form of a riser which is inserted as needed within the display section housing so as to raise the media packaging for display.

3. The display of claim 2, wherein the dimensions of the base and display section are altered in manufacturing to accommodate specifically the individual dimensions of various digital media display cases so as to eliminate the need for the riser.

4. The display of claim 2, wherein said display section is made from plastic, wood, ceramic, metal, corrugated board, porcelain, china, carbon fiber, clay, or other material, as multiple pieces or as a single piece requiring no assembly by the user and the riser is included as a separate piece.

5. The display of claim 2, wherein said base is made from plastic, wood, ceramic, metal, corrugated board, porcelain, china, carbon fiber, clay, or other material, and the display section is made of a different material than the base, such as a unit with a porcelain base and a wood display section.

6. The display of claim 2, wherein said riser which serves as the orientation mechanism is replaced with a mechanism built into the back of the display section which allows the media packaging to be vertically and/or horizontally adjusted within the visible area of the display window. Alternate mechanisms include, but are not limited to, adjustable sliders, notched shelves, and magnet sliders.

7. A digital media case display unit, comprising:
a construction design such that the base and display section are integrated into a single piece wherein the shape and dimensions are such that the entire single unit stands alone;
a hollow display section in the front of the unit of sufficient height to hold within it a digital media case or artwork and with an opening in the front to allow the major portion of the front of the digital media case to show through to the user; and
an orientation or adjustment mechanism or additional piece that allows for adjustment of various sizes of media packaging to be visible while housed in or on the display section.

8. The display of claim 7, wherein the invention is made of paperboard and designed to be folded and locked into a usable unit by the user wherein the adjustment mechanism is a riser which is inserted as needed within the display section housing so as to raise or lower the media packaging for display.

9. The display of claim 7, wherein the support is provided by vanes which protrude to the rear, front, or both.

10. The display of claim 7, wherein the support is provided by wings on either side that angle either to the front or back.

11. The display of claim 7, wherein there is a hole or other indentation in the back of the unit to allow the support of the unit to be provided by hanging it on the wall.

12. The display of claim 7 and its related permutations, wherein the dimensions of the display upright are altered in manufacturing to accommodate specifically the different dimensions of alternate digital media display cases so as to eliminate the need for the riser or other orientation mechanism.

13. The display of claim 7 and its related permutations, wherein the display is made from plastic, wood, ceramic, metal, corrugated board, porcelain, china, carbon fiber, clay, or other material as multiple pieces or as a single piece requiring no assembly by the user. The riser is included as a separate piece. The individual parts of the unit can be made of different materials.

14. The display of claim 12 wherein the display is made from plastic, wood, ceramic, metal, corrugated board, porcelain, chine, carbon fiber, clay, or other material as multiple pieces or as a single piece requiring no assembly by the user. The individual parts of the unit can be made of different materials.

15. The display of claim 7, wherein the riser is replaced with a mechanism built into the back of the display section which allows the media packaging to be vertically and/or horizontally adjusted within the visible area. Alternate mechanisms include, but are not limited to, adjustable sliders, notched shelves, and magnet sliders.

16. A display unit which performs the stated function of display wherein the artwork being displayed is not the media packaging, but is artwork associated with the media which is in non-rigid form such as a poster or printout. Rather than a hollow housing for the display section, the upright display section would allow the printed artwork to be held within a clear display or attached to the upright section in such a manner as to hold it vertical.

17. A digital media case display unit, comprising a base of sufficient height, weight, and design to allow the support of a media case without any additional housing in an upright position on top of the base. Further, the base is of sufficient size to allow for the marquee artwork.

18. The display of claim 17, wherein the case is held in a shallow slot of sufficient width and depth to hold the case on top of the base.

19. The display of claim 18, wherein the unit is made of paperboard and designed to be put together by the user.

20. The display of claim 18, wherein the display is made from plastic, wood, ceramic, metal, corrugated board, porcelain, china, carbon fiber, clay, or other material as a single piece requiring no assembly by the user.

21. The display of claim 17, wherein the top of the base is flat and attached to it are two vertical plates of sufficient height to hold the case vertically. The media case is held rigidly vertical against the front plate by an adjustable back plate that pinches the case against the similarly sized front plate.

22. The display of claim 21, wherein the display is made from plastic, wood, ceramic, metal, corrugated board, porcelain, china, carbon fiber, clay, or other material, and the two vertical plates are made of the same material or an alternate material of sufficient rigidity to provide the vertical support of the case. For example, it can be a wood base with vertical metal plates.

23. A media packaging display unit, comprising:
a construction design such that the base and display section are incorporated into a single piece wherein the shape and dimensions are such that the entire unit stands alone;
a hollow upright display section in the front of the unit of sufficient height to hold within it media packaging material and with an opening in the front to allow the major portion of the front of the media packaging material to show through to the user; and
an electronic digital display unit which is located at some distance behind the opening in the front of the display section and is adapted to be visible when no media packaging is inserted to display digital media information related to the media being used or other advertising or company marketing-related information that is transmitted through digital means.

24. The display of claim 23, wherein the digital means is a wireless connection to a computer to transmit and receive the digital display content.

25. The display of claim 23, wherein the digital means is a wired connection to a computer to transmit and receive the digital display content.

26. The display of claim 23, wherein the digital means is a digital drive interface including, but not limited to, SD, USB drive, CF, Microdrive, or other digital storage device.

27. A media artwork display unit, comprising:
a stand-alone electronic display which captures or receives and then displays information related to the media being used; and
a housing around the display unit for displaying the personal marquee artwork.

28. The display of claim 27, wherein the housing is eliminated and the personal marquee artwork in various incarnations is programmed to be part of the electronic display.
